(19) United States
(12) Patent Application Publication
(10) Pub. No.: US 2007/0100782 A1
(43) Pub. Date: May 3, 2007

(54) Method and apparatus for workflow interactive troubleshooting tool

(76) Inventors: Tom M. Reed, O'Fallon, MO (US); Erian Laperi, Wentzville, MO (US); Jeremy Andrew Dilks, East Alton, IL (US); Jonathan S. Gray, Hazelwood, MO (US)

Correspondence Address: BRINKS HOFER GILSON & LIONE, P.O. BOX 10395, CHICAGO, IL, 60610, US

(21) Appl. No.: 11/262,476

(22) Filed: Oct. 28, 2005

(51) Int. Cl. G06F 17/30

(52) U.S. Cl. 707/1

(57) ABSTRACT

A method and system for providing a workflow integrated troubleshooting tool. The system may include a central workflow server from which network technicians may obtain trouble tickets and with which the technician may analyze and solve problems identified in the trouble tickets. The workflow server may automatically provide recommended workflows to technicians with step-by-step guidance instructions accompanied by relevant links to appropriate diagnostic software tools. The workflow server mediates between formats of information from a customer database and from any of a number of diagnostic software applications. The method may include permitting a technician centralized login and authentication to each of a number of separate diagnostic tools, prioritization of trouble tickets and automated workflow suggestions and testing through a common graphic user interface.

### TECHNICAL FIELD

The disclosure below relates to troubleshooting tools for networks.

### BACKGROUND

Users of network systems invariably run across difficulties with connectivity or the availability of certain services for their account. Service providers of networks expect to receive a number of service calls and questions relating to connectivity or responsiveness available at certain user accounts and these networks and service providers need to provide troubleshooting solutions in an efficient manner. With larger networks or service providers, the challenge is not only to quickly and correctly answer questions and provide solutions to problems, but also to proficiently handle the dissemination of trouble tickets to the appropriate technician in the system and manage the administrative overhead. The administrative overhead may include the assignment of particular trouble tickets or tasks among departments at the network or service provider, and the record and audit trail of which customers have been assisted or still require follow up assistance.

Even with a single diagnostic tool available to network and service provider technicians, there is the possibility of inefficiency or error in handling trouble tickets. When multiple diagnostic tools are available, the possibility of user error and efficiency problems can increase. This is particularly true when there are a number of network technicians located in various geographical regions who may each have their particular preference as to which diagnostic tool to use and in what order. In such an environment, the burden to networks or service providers for updating troubleshooting procedures, whether on the use or introduction of particular diagnostic tools or the communication format that should be used internally to efficiently transfer trouble tickets or tasks, can be tremendous.

Accordingly, there is a need to provide improved workflow management to network and service provider troubleshooting.

### BRIEF SUMMARY

In order to address the need for improved management of network and service provided troubleshooting, a telecommunication diagnostic system for troubleshooting telecommunication user accounts is disclosed. In one aspect, the system may include a workflow processor configured for communication with an account database containing telecommunication user account information and for communication with a plurality of telecommunications diagnostic applications. An interface application in communication with the workflow processor may be configured to provide instructions for generating a graphic user interface at a client device accessing the workflow processor. A workflow procedure database in communication with the workflow processor may also be included. The workflow procedure database may have procedures for troubleshooting each of a number of predetermined trouble report categories typically received for telecommunication user accounts. In one embodiment, each of the procedures includes instructions and workflow integrated links to at least one of collection of telecommunications diagnostic applications relating to the instructions, where each step of the selected workflow may be sent to the client device for display on the graphic user interface.

In another aspect, a method for troubleshooting telecommunication user accounts is described. In response to receipt of a technician login query from a client device, a workload is retrieved from a telecommunications user account database, where the workload comprises telecommunication user account information for telecommunication user account trouble tickets assigned to the technician. Initial testing of telecommunication user accounts retrieved in the workload is then automatically executed and the telecommunication user account information and results of the initial testing for a selected one of the plurality of telecommunication user accounts may be sent to the technician at the client. A troubleshooting workflow, from a predetermined collection of workflow options, is suggested to the technician based on the telecommunication user account information and the initial testing results. In one embodiment, step-by-step instructions associated with the suggested workflow are transmitted to the client. The instructions may include one of more links to pre-selected diagnostic testing applications relating to the instructions.

According to another aspect, an article of manufacture, such as a computer readable medium, may be provided containing instructions for executing the steps of the method noted above. Additional features may include, instructions for automatically prioritizing an order of the plurality of telecommunications user accounts assigned to the technician based on at least one priority parameter, such as a length of time that a trouble ticket for the telecommunications account has waited for attention. The computer readable medium may also include instructions for automatically updating an activity log associated with the telecommunications user account with diagnostic test activity and results from the workflow. Also, the instructions may include an option for exempting the technician from following the automatically suggested workflow upon receipt of an exemption request from the technician.

### BRIEF DESCRIPTION OF THE DRAWINGS

FIG. 1 illustrates an embodiment of a telecommunications user account troubleshooting system.

FIG. 2 is a block diagram of a workflow server for use in the system of FIG. 1.

FIG. 3 is a flow diagram of an embodiment of a troubleshooting process executable on the system of FIG. 1.

FIG. 4 illustrates an initial display screen that may be generated at the client shown in FIG. 1.

FIG. 5 illustrates an embodiment of a graphic user interface for a dashboard view that may be generated at the client shown in FIG. 1.

FIG. 6 illustrates an embodiment of a graphic user interface for a display on a client that shows a recommended workflow for addressing a particular trouble ticket.

FIG. 7 is a sectional view of the graphic user interface of FIG. 6, illustrating a manual workflow selection option.

FIG. 8 is an example pre customer contact workflow for addressing a trouble ticket from a DSL customer where the DSL equipment is located at a central office and the reported trouble is no synchronization.

FIG. 9 is an example pre customer contact workflow for addressing a trouble ticket from a DSL customer where the DSL equipment is located at a central office and the reported trouble is intermittent synchronization.

FIG. 10 is an example pre customer contact workflow for addressing a trouble ticket from a DSL customer where the DSL equipment is located at a central office and the reported trouble is slow connection speed.

FIG. 11. is an example pre customer contact workflow for addressing a trouble ticket from a DSL customer where the DSL equipment is located at a central office and the reported trouble is no connectivity.

FIGS. 12-15 are example workflows involving customer contact and complementing the pre customer contact flows of FIGS. 8-11, respectively.

FIG. 16 is a block diagram of a general computer system adaptable for use in the system of FIG. 1

### DETAILED DESCRIPTION OF THE DRAWINGS

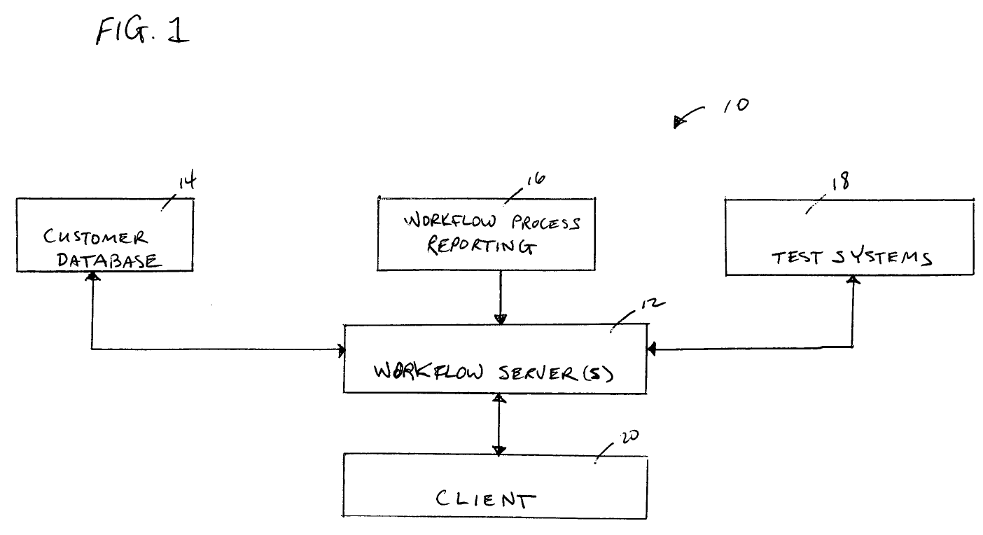

In order to provide for improved efficiency and uniformity in network troubleshooting, and to permit rapid and transparent process upgrades to preferred troubleshooting workflows, a system 10 is disclosed in FIG. 1 having a central workflow server 12. The system 10 includes a customer database 14 in communication with the workflow server 12. The customer database 14 may be one or more servers containing customer connectivity information, service choices, billing address information, trouble ticket reports and other general customer information relevant to the troubleshooting system. The customer database may be configured in a WFA (workflow administration) format or other commonly known database format. One suitable WFA format is supported by Telcordia Technologies, Inc. of Piscataway, N.J.

The workflow server 12 receives updates on WFA reporting applications from a workflow process reporting module 16. Suitable reporting applications may include Open Query System (OQS), Symposium ACD or other known Web-based reporting tools. A test system server 18, which may include a number of discrete, imbedded test systems or Internet links to remotely stored testing programs, communicates with the workflow server 12 over one or more communication lines. The test systems may include tests for network circuit integrity and responsiveness. Examples of testing applications that may be included in the test systems 18 may be Circuit Manager, COPPERMAX, BROADBAND TOOLS, MLT, and REDBACK TOOLS. The system 10 includes one or more remotely located clients 20 in communication with the workflow server 12. In one embodiment, the client may be a personal computing device such as a personal computer with standard Internet web browser, which may communicate with the workflow server 12 at a standard IP address. In this embodiment, the client device would not need any customer data or testing applications stored locally. A network center technician (NCT) or other user at the client 20 would access all customer information and testing procedures via the workflow server 12.

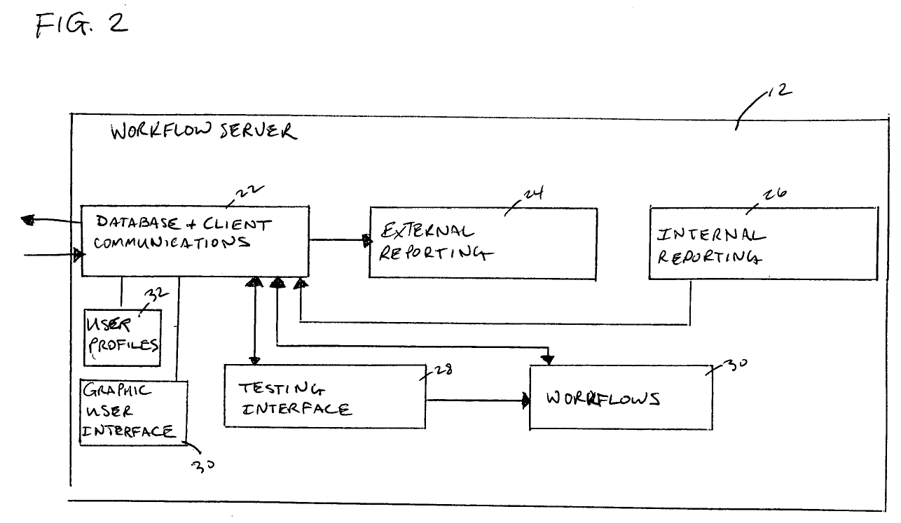

One embodiment of a workflow server 12 as shown in FIG. 2. A database and client communication module 22 communicates with the customer database 14, workflow process reporting server 16, embedded or remote test systems 18 and client 20. The communication module 22 routes information received at the workflow server 12 to the appropriate internal process. One of the processes in the workflow server 12 may be an external reporting module 24 that imports and imports and processes trouble tickets, such as WFA/C reports, and generates work lists for the various NCTs that access the workflow server 12 via remote clients 20.

In one embodiment, the external reporting module 24 parses through the work requests, commonly known as trouble tickets, obtained from the customer database 14 and prioritizes the workload for each respective NCT so that NCTs accessing their workload information from a client 20 will automatically receive that workload prioritized with the highest priority trouble ticket coming first. The prioritization and distribution of workload among NCTs may be modified by the service provider controlling the workflow server 12. Examples of prioritization methods for prioritizing the trouble tickets assigned to an NCT include ranking the trouble tickets by the time a customer account has waited for attention, the number of inquiries received for a customer account, the type of account (e.g., business or residential), or any other field available in the customer account database.

The communications module 22 also receives information from an internal reporting module 26 at the workflow server 12 that monitors and provides overall statistics of the progress of NCTs and the status of individual trouble tickets. For example, the internal reporting module 26 may be configured to collate and distribute statistics such as how many trouble tickets were handled on any given day by all NCTs, a specific NCT, NCTs of a particular geographical region or business unit and so on. Administrators for the troubleshooting system 10 may then adjust methods and procedures if trends in NCT activity indicate possibilities for improvement.

The testing interface 28 of workflow server 12 may be provisioned to communicate with diagnostic tools stored at the test systems server or accessible through the test systems server 18 in communication with the network 10. The testing interface module 28 facilitates remote testing of circuits, processes, and processing of test results received from the various diagnostic tools in the test systems 18. The testing interface module 28 also retains testing information and provides for consistent interpretation and logging of test results. The testing interface module 28 processes and stores client-based and automated testing results from the customer database log. The customer database log, in one embodiment may be a WFA4/C OSSLOG storing a complete log of customer service and status information in WFA format. The workflow server 12 also stores instructions for generating a graphic user interface 30 for transmission to clients 20 when a user, such as an NCT, wishes to access the various diagnostic tools and reporting information from the workflow server 12.

One advantage of the workflow server applications is the combination of access to all testing tools through one interface. This single interface reduces the workload on an NCT by, for example, removing the need to type in information or copy and paste information between separate systems multiple times during the processing of a particular trouble report. The modules in the workflow server 12 may be implemented via a graphic user interphase that calls JAVA or VB script functions to launch applications at the workflow server 12. The Web-based front-end allows the back-end applications at the workflow server to parse and summarize data in a manner similar to web-based applications. For example, all authentications for users such as NCTs at a client 20 may be handled by scripts transferred through the GUI scripts passed to a client 20 by the communications module 22. A first time user would be queried to enter the various passwords to each of the separate diagnostic tools test systems 18, and to the workflow server 12 itself, when he logs into the workflow server from a client 20. This user profile is then stored in a user profile database 32. The user profile for a particular NCT or other user may then be accessed in subsequent session through a single password to the workflow server 12. In this manner, all security and password handling may be managed at the workflow server based on the single workflow server login. The functionality of the modules of the workflow server level may be implemented in any of a number of programming languages. In one embodiment, the workflow server 12 is programmed in Perl and is configured to work with a customer database provisioned in IMSC65 WFA4-C format such as the WFA system software available from Telcordia Telecommunications, Inc.

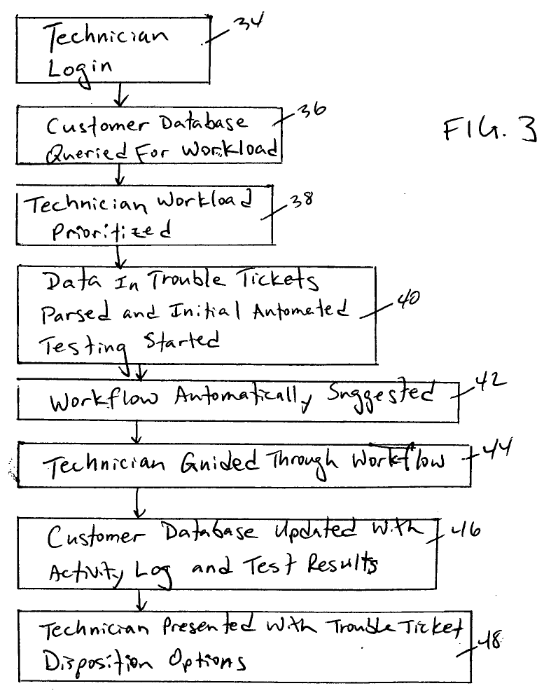

Referring to FIG. 3, an overview of a generic process flow supported by the workflow server 12 in a network 10 such as disclosed in FIG. 1 is described. Assuming an NCT has previously filled out a user profile with all the appropriate passwords for each system and for diagnostic application available via the test systems server 18, the technician logs in to the workflow server 12 via a log in interface on the client's 20 work browser (at step 34) once the login information is complete, the workflow server 12 queries the customer database 14 for the technician's assigned trouble tickets that comprise the technician's current workload (at step 36) using predesignated prioritization parameters, the workflow server 12 prioritizes the technicians trouble tickets (at step 38). The prioritization parameters may be any of the number of factors such as elapsed time from a customer's initial inquiry regarding a network problem. The workflow server 12 than parses the data in the selected trouble tickets for the technician and automatically initiates certain tests (at step 40). In one embodiment, the automatic initial testing is performed by the workflow server prior to the NCTs receipt of his workload. In one embodiment, where the customer accounts relate to digital subscriber line (DSL) services, the initial automated testing may include tests of the line length, DSL modem response, and line tests for upstream and downstream performance including noise margin, attenuation, bit rate, cell counts and so on. Any of a number of known testing programs may be used in these initial automated tests and may be stored in, or accessible by, the test systems server 18. Examples of suitable diagnostic programs for the initial automated tests of DSL connections include MLT and COPPERMAX/REACT.

Once a trouble ticket is selected by the technician, the workflow server automatically suggests to the technician one of a predetermined number of workflows stored in the workflow database 30 based on the information available on the trouble ticket and from the initial testing (at step 42). The initial customer account complaints trigger the automated workflow selection. However, if initial test results do not match the customer account complaint listed in the trouble ticket, the workflow server highlights the difference and suggests that the technician use the workflow that best matches the test results. The automatically selected workflow guides the technician through step-by-step questions and provides instructions for testing and obtaining further information. The workflow also automatically executes diagnostic routines, or presents links to these routine to the NCT, from one or more of the applicable diagnostic applications on the test systems server (at step 44). The customer database 14 is updated with the activity log and data of the troubleshooting efforts as the workflow proceeds (Step 46). Depending on the workflow automatically selected for the particular trouble ticket guidelines for customer, contact with the internet service provider (ISP) or other facility, and final disposition of a trouble ticket are presented to the technician in the step-by-step manner (at step 48). Further disposition alternatives for the trouble ticket may include, but are not limited to, referral to another department for assignment to a field technician to address a line problem, escalation of the trouble ticket if diagnostic applications do not solve the problem, and closing of the trouble ticket if the NCT was able to fully resolve the problem on the customer account identified in the trouble ticket. For each of the disposition options, the workflow server 12 may pre-populate trouble ticket disposition forms designated for the specific type of disposition relevant to the trouble ticket with some or all of the necessary customer account information and test results. The forms may be HTML forms or other types of forms accessible from the external reporting module 24 in the workflow server and retrieved automatically for, or manually by, the workflow server as part of the selected workflow.

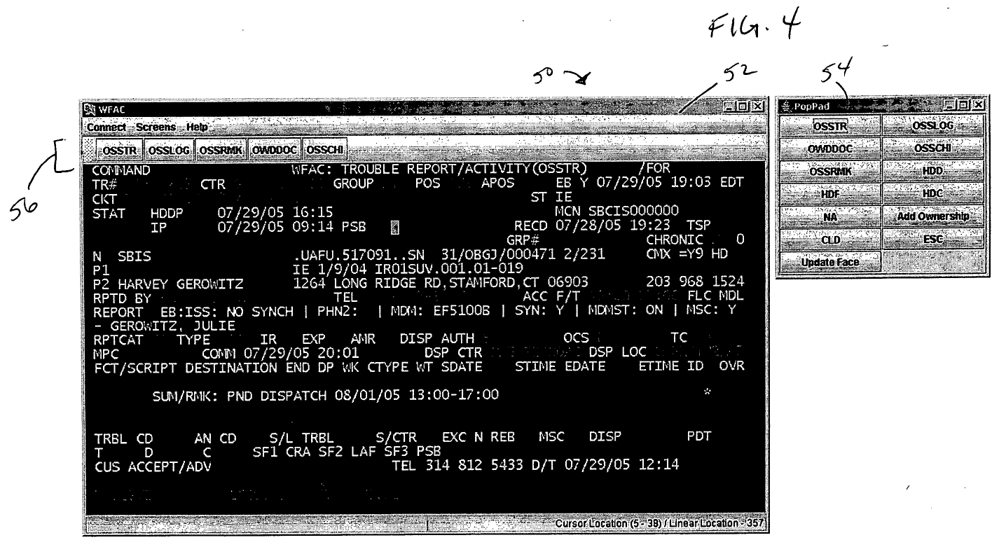

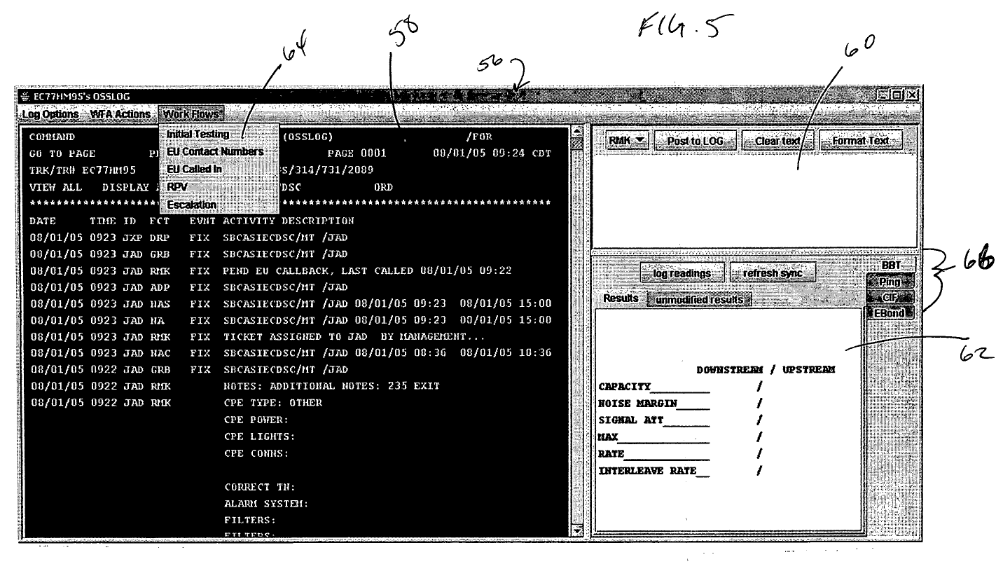

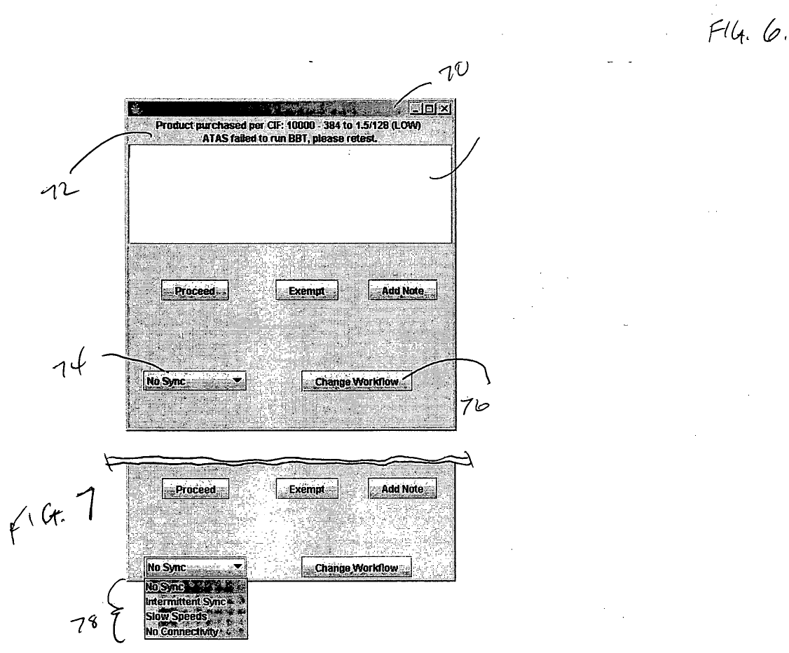

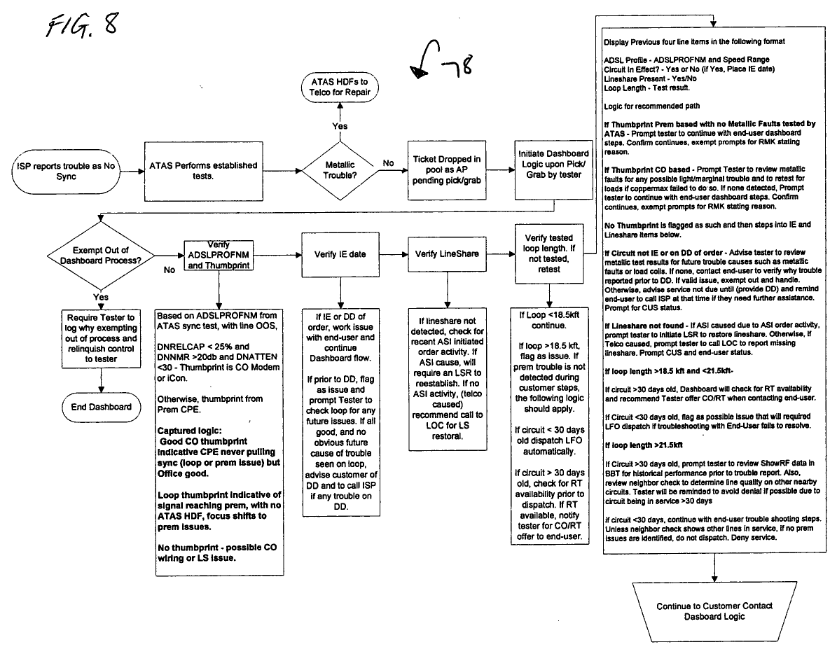

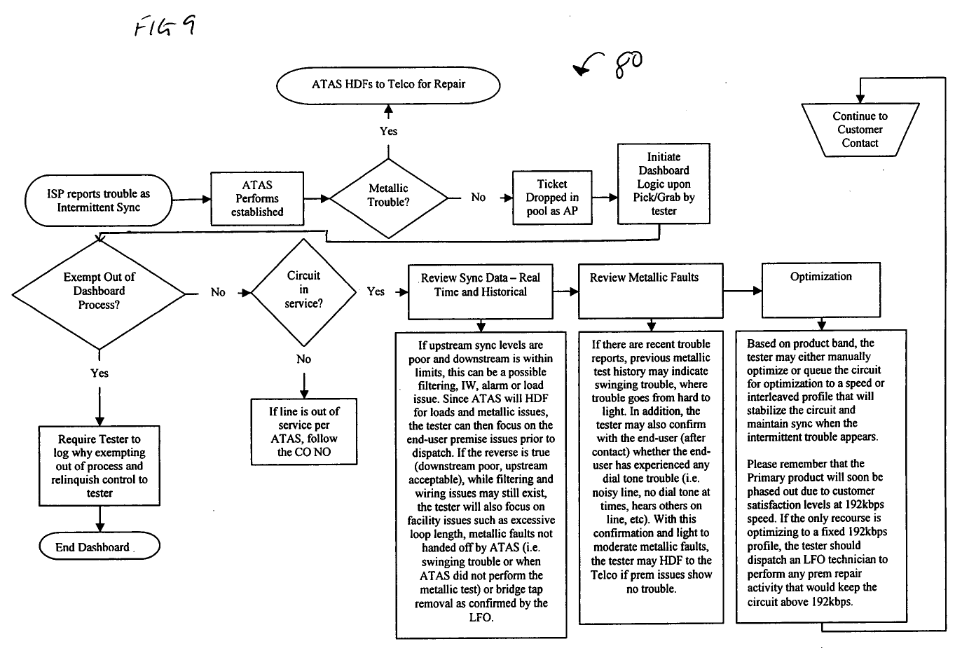

User accessible screens of the graphic user interface available at the client 20 may be seen in FIGS. 4-7. After completing an initial login, the user is shown a main ticket review dashboard 50 consisting of a trouble ticket review window 52 and a function window 54 as shown in FIG. 4. Ticket review window 52 may show an individual trouble ticket in a standard workflow format, such as WFA and may provide a number of separate data view buttons 56. The ticket review screen 52 is shown when the OSSTR (operational supporting system ticket review) is pressed. A review such as the ticket log (OSSLOG) a remark window (OSSRMK) an extended ticket review display (OWDDOC) and a circuit/account history window (OSSCHI) are also available through the basic view screen 52. In contrast, the function pad 54 provides shortcuts to views with applicable logic and for some of the same features shown in screen 52.

Referring to FIG. 5, a technician addressing a trouble ticket will select a OSSLOG function key from function pad 54 and be shown a dashboard view 56 with three separate windows. A first window 58 displays a scrollable ticket log screen showing the particular history of a trouble ticket. The second window 60 provides space for a quick comment box for adding information and remarks to the trouble ticket log. The test result window 62 is displayed in the lower right hand corner showing results from initial tests already performed on the circuit for the selected customer. Although a workflow will be suggested to a technician upon selection of a workflow stage in the pull down menu 64, the test result window 62 includes a plurality of diagnostic tests tab 66 that can allow the technician to call up specific hardware tests for the circuit to which the trouble ticket relates. Choosing the initial testing selection from the workflow pull down menu 64 brings up an initial testing screen 70 such as shown in FIG. 6. The initial testing screen 70 may appear as a separate box opened within the same screen as FIG. 5.

The initial testing screen 70 includes technician procedure information 72 that advises the technician review the network provisioning and record keeping information maintained on customer accounts (e.g. customer profile including connection speed for a customer's telecommunication user account) and any automated initial testing that is desired, and post a summary of those results. Examples of initial automated tests include loop length, line voltage, grounding and other related circuit characteristics. The automatically selected workflow path 74 that has been selected by the workflow server based on the initial test results and telecommunication user account information is presented in a pull down menu of available workflow paths for NCT use. If a technician wishes to change a workflow from the recommended path, the change workflow button 76 on the graphic user interface allows technician to do so. As shown in FIG. 7, the available workflow options 78 are displayed in pull down menu. In one embodiment, where the network service is a digital subscriber line (DSL) service, the preselected troubleshooting process paths (workflows stored in the workflow database) may include no sync and intermittent sync workflows, a slow speed workflow, and a workflow for no connectivity. Workflows for troubleshooting any of a number of other customer trouble report inquiries may also be added depending on the type trouble reports pertinent to the particular system.

Once the workflow has been automatically selected by the workflow server based on the initial tests run by the workflow server 12, specific guidance instructions will be presented to the technician according to the selected workflow stored in the workflow database 30. The NCT will be directed to answer yes or no to specific questions and portions of the various applications of the test systems 18 will be accessed by the workflow server to provide the technician with test result data as the workflow progresses. The NCT will also be prompted to contact the customer reporting the problem in certain of the workflows.

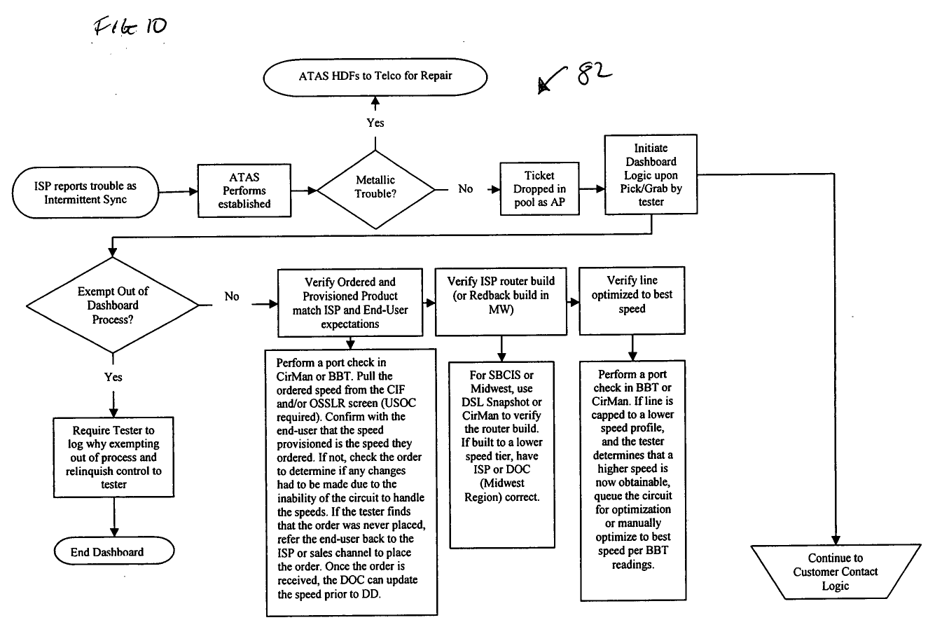

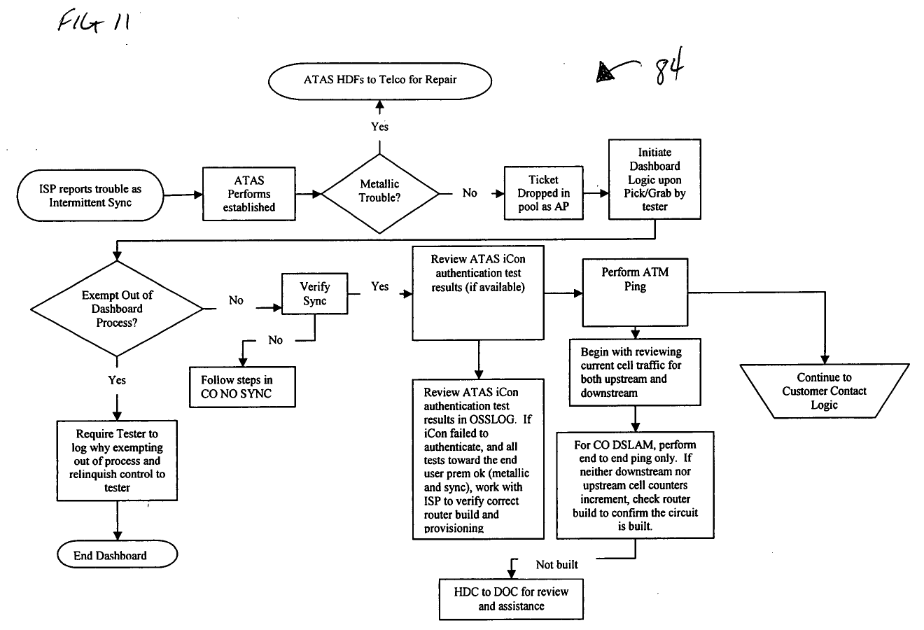

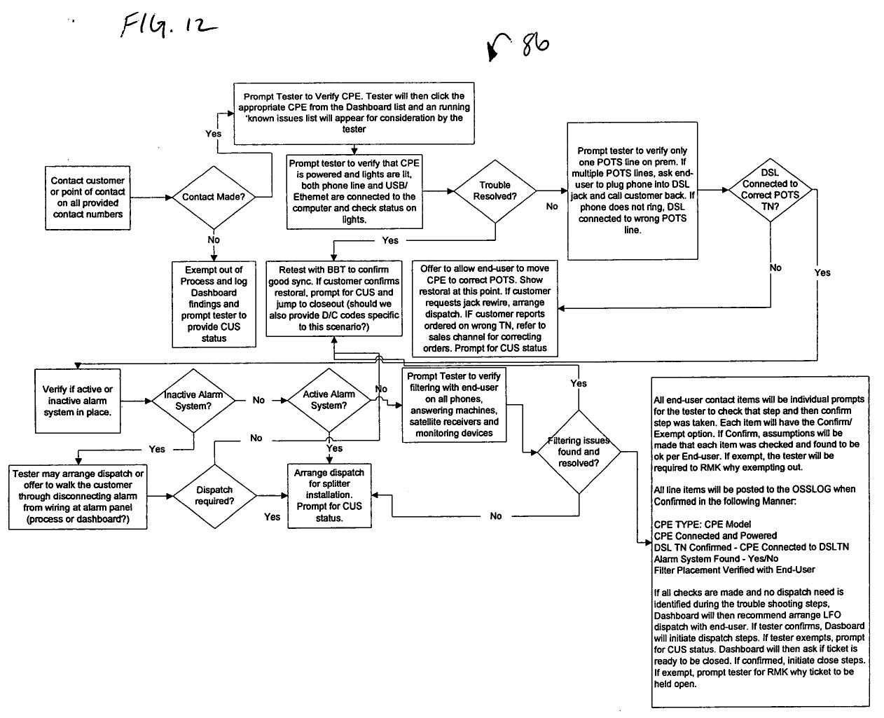

Referring FIGS. 8-11, example workflows are shown for NCT activity prior to contacting a customer. FIG. 8 discloses a workflow 78 for a situation where a customer has reported no synchronization (no sync) with their DSL service. FIG. 9 illustrates a workflow 80 where the customer report is for intermittent synchronization. The workflow 82 in FIG. 10 relates to NCT steps for addressing customer reports of slow connection speeds. In FIG. 11, the workflow 84 for an NCT is shown where no connectivity to the DSL network is reported. The workflows of 8-11 illustrate those steps that the workflow server will feed to a technician at a client device 20 where information from, or manipulation of CPE by, the customer is unnecessary.

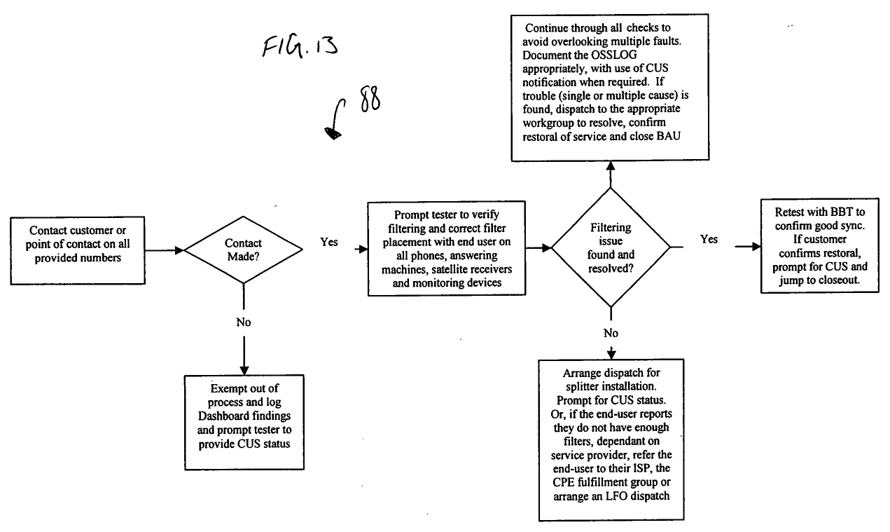

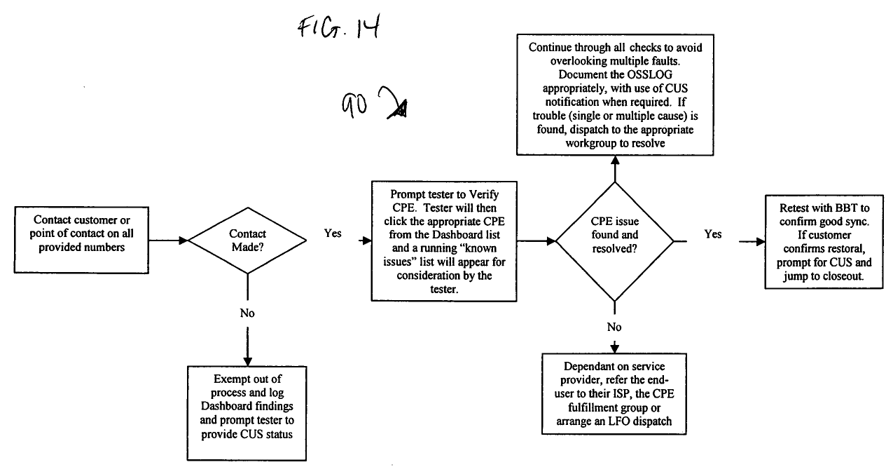

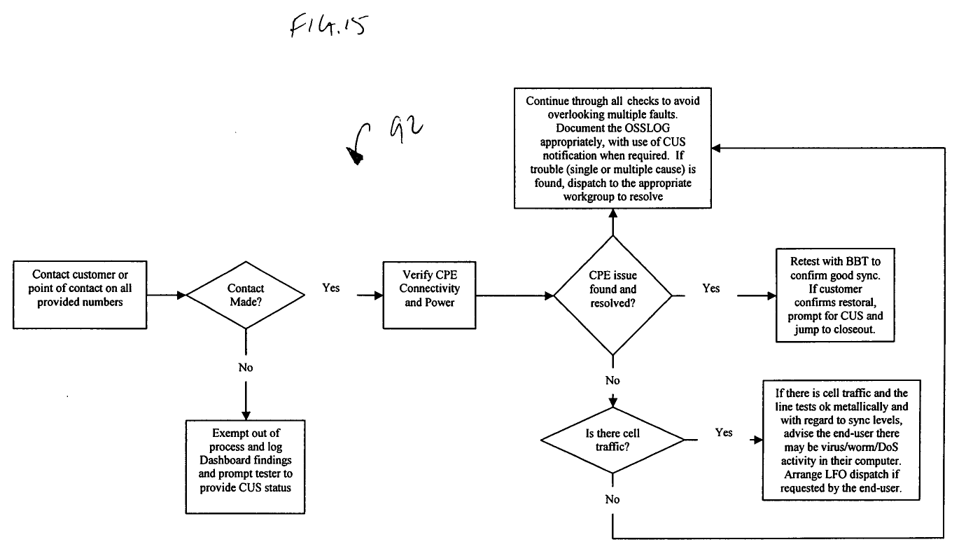

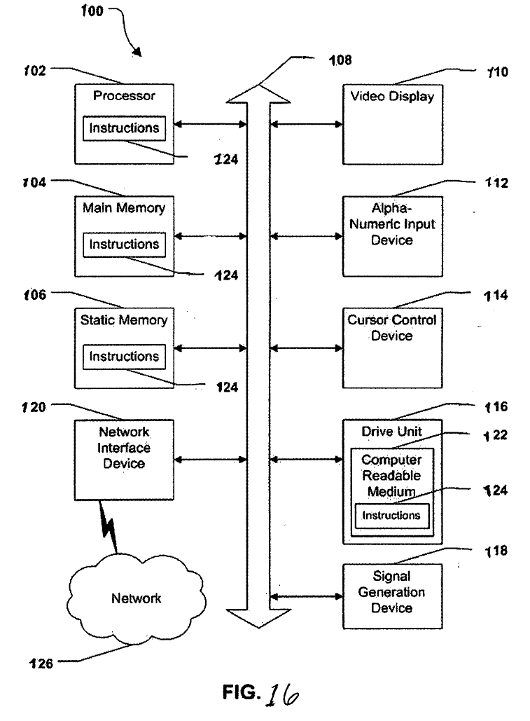

In addition to workflows allowing the NCT to work on troubleshooting problems without customer contacts, there may be instances where customer action is necessary in order for the NCT to analyze the problems that may be occurring at the customer's CPE. FIGS. 12-15 illustrate example workflows that may be used after exhausting the pre-customer contact workflows of FIGS. 8-11. FIG. 12 discloses a workflow 86 for guiding an NCT through a customer contact situation when the customer is experiencing a no-sync difficulty. FIG. 13 illustrates a customer contact workflow 88 for the NCT to work with the customer on an intermittent sync problem. The workflow 90 in FIG. 14 relates to steps for an NCT to take in customer contacts relating to slow speed issues. In FIG. 15, the workflow 92 includes customer contacts steps for an NCT when the problem is no connectivity to the DSL network. In the customer contact workflows of FIGS. 12-15, initial information and guidance for an NCT is to contact customer using any contact numbers available through the customer database and, if contact is not made, the workflow takes the NCT out of the dashboard view and prompts the NCT to provide a customer status remark for the trouble ticket log. If contact is made with the customer, the NCT is prompted to have the customer make the changes (e.g. alter DSL filter placement, verify that a modem is plugged in and powered up, etc.) and continue through a checklist to avoid multiple faults even if the CPE issue is found and resolved.

For each of the pre-customer contact workflows of FIGS. 8-11 and customer workflows of FIGS. 12-15, any of a number of diagnostic routines from stand-alone embedded or remotely located diagnostic programs may be called upon. An advantage of the workflow server with its configurable workflow database is that the administrator for the workflow server can easily and transparently update these workflows to take advantage of different routines within an existing diagnostic program or completely new routines in completely new diagnostic programs. This centralized reprogramming of workflows eliminates the need to propagate changes to diagnostic methods and procedures for a service provider and improves uniformity of application. Only a limited retraining, if any, is necessary for NCTs using the workflow system described because the automatically selected workflows are constructed to walk NCTs through predesignated steps and reduce or eliminate the need for individual training in how to use the discrete diagnostic tools available within the system.

Additionally, the integration of a workflow database, such as WFA, within a single graphic user interface created at client device 20 accessing the workflow server 12 helps to reduce any need for re-keying of information between disparate diagnostic tools and internal administrative forms. For example, when an NCT reaches a phase of his review of a particular customer's DSL problem, there would likely be a hand-off to other offices within an organization, for example field technicians, to dial with the problem that has been diagnose through the workflow. The forms and communication protocols for transmitting this information may be streamlined through the single graphic user interface produced at a client. Furthermore, these centralized forms and procedures for internal communication and trouble ticket handoff may also take advantage of the integration with the customer and workflow database to prepopulate forms and provide centralized updating capabilities so that separate offices do not require separate copies of upgrades or changes to the procedures and forms.

In addition to the example workflows shown in FIGS. 8-15 for DSL services where the DSL equipment resides in a central office (CO) separate, or slightly altered, workflows may be automatically generated for situations where customers account routes through a portion of a system where the DSL equipment is located at a remote terminal away from a central office. Situations where the DSL equipment may be located in a remote terminal includes where the customer location is too far away from the central office to permit proper DSL communications and a shorter loop from a remote terminal to the CPE of a customer is necessary. In these situations, the remote terminal may be connected to the central office through a fiber optic connection to minimize transmission losses that can limit the availability of DSL service. The customer account information in the customer database may include a flag indicating which type of connection, RT or CO, applies to the account so that the workflow server automatically pull the correct version of the workflow necessary to address that customer's needs. This information may be determined from a look-up table that uses the customer's line code or telephone number that is stored in the customer database and included in the trouble ticket.

Examples of embedded diagnostic tools that may be accessed by the workflow server at appropriate points in the predetermined workflows include Broadband Tools (BBT), ATAS, in other applications that perform tasks such as physical layer testing via applications such as COPPERMAX or MLT, logical layer testing using COPPERMAX iCON or with embedded test capabilities in the network equipment (available, for example in REDBACK or JUNIPER router), and configuration testing through such systems as BBT, TOOL BAR or other record-keeping systems. Examples of remotely accessible tools from third parties that may be incorporated into a diagnostic routine such as supported through the work flow server include WFA AX, TOOL BAR, and COPPERMAX. WFA AX and TOOL BAR are applications available from Telcordia Telecommunications. COPPERMAX, and one of its variations with separate interface known as REACT, is available from Spirent Communications of Rockville, Md.

In alternate embodiments, one or more of the specific workflows may access all or only part of a single discrete diagnostic application. Also, it is contemplated that one or more workflows may not require any separate diagnostic tools and may only need to interface with the customer database to update the trouble ticket log to indicate the gathering of information for completion of the workflow steps for that particular workflow. In addition to the centralized ability to transparently update methods and procedures for the workflows through the central workflow server, it is contemplated that the graphic user interface may be updated or altered by allowing the system administrator to change the scripts sent to a client web browser when a client queries the workflow server. Also, while a DSL system is described in the context of the specification, the workflow server and methods may be applied to any one of a number of other telecommunication services requiring customer trouble diagnosis, or even call center management for calls from consumers of any of a number of products including insurance products or other retail products.

Any of a number of computer devices can be used for the workflow server 12, client 20 or other components of the network 10. Referring to FIG. 16, an illustrative embodiment of a general computer system is shown and is designated 100. The computer system 100 can include a set of instructions that can be executed to cause the computer system 100 to perform any one or more of the methods or computer based functions disclosed herein. The computer system 100 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 16, the computer system 100 may include a processor 102, e.g., a central processing unit (CPU), a graphics processing unit (GPU), or both. Moreover, the computer system 100 can include a main memory 104 and a static memory 106 that can communicate with each other via a bus 108. As shown, the computer system 100 may further include a video display unit 110, such as a liquid crystal display (LCD), an organic light emitting diode (OLED), a flat panel display, a solid state display, or a cathode ray tube (CRT). Additionally, the computer system 100 may include an input device 112, such as a keyboard, and a cursor control device 114, such as a mouse. The computer system 100 can also include a disk drive unit 116, a signal generation device 118, such as a speaker or remote control, and a network interface device 120.

In a particular embodiment, as depicted in FIG. 16, the disk drive unit 116 may include a computer-readable medium 122 in which one or more sets of instructions 124, e.g. software, can be embedded. Further, the instructions 124 may embody one or more of the methods or logic as described herein. In a particular embodiment, the instructions 124 may reside completely, or at least partially, within the main memory 104, the static memory 106, and/or within the processor 102 during execution by the computer system 100. The main memory 104 and the processor 102 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 124, or receives and executes instructions 124 responsive to a propagated signal, so that a device connected to a network 126 can communicate voice, video or data over the network 126. Further, the instructions 124 may be transmitted or received over the network 126 via the network interface device 120.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A telecommunication diagnostic system for troubleshooting telecommunication user accounts, the system comprising:
a workflow processor configured for communication with an account database including a plurality of telecommunication user accounts and for communication with a plurality of telecommunications diagnostic applications;
an interface application in communication with the workflow processor and configured to provide instructions for generating a graphic user interface at a client device accessing the workflow processor;
a workflow procedure database in communication with the workflow processor and comprising procedures for troubleshooting each of a plurality of trouble report categories for the telecommunication user accounts, wherein each of the procedures comprises instructions and workflow integrated links to at least one of the plurality of telecommunications diagnostic applications relating to the instructions.

2. The system of claim 1, wherein the instructions for generating a graphic user interface comprise instructions for generating a dashboard view comprising concurrent display of an event log window for display of customer account database information and a test result window for displaying test results from at least one of the plurality of telecommunications diagnostic applications.

3. The system of claim 2, wherein the instructions for generating a graphic user interface further comprise instructions for generating a remarks window for entry of troubleshooting progress notes concurrently with the event log and testing windows.

4. The system of claim 1, further comprising a telecommunications diagnostic system user profile database comprising login information associated with each system user, wherein the login information for each system user comprises login information for each of the plurality of telecommunications diagnostic applications.

5. The system of claim 1, wherein the procedures contained in the workflow procedure database comprise procedures for diagnosing DSL connections.

6. The system of claim 5, wherein the procedures contained in the workflow procedure database further comprise procedures for diagnosing DSL connections without contacting a DSL customer.

7. The system of claim 5, wherein the procedures contained in the workflow procedure database further comprise procedures for diagnosing DSL connections requiring contact with a DSL customer.

8. The system of claim 1, wherein the telecommunications diagnostic applications comprise diagnostic applications remotely located from the workflow processor via an Internet link.

9. The system of claim 8, wherein the telecommunications diagnostic applications further comprise diagnostic applications embedded in a memory in a LAN with the workflow processor.

10. A method for troubleshooting telecommunication user accounts, the method comprising:
receiving a technician login query from a client device;
retrieving a workload from a user account database, the user account database having a plurality of telecommunication user accounts, wherein the workload comprises a plurality of telecommunication user account information for telecommunication user account inquiries assigned to the technician;
automatically executing an initial testing of telecommunication user accounts retrieved in the workload;
transmitting to the client device information comprising telecommunication user account information and results of the initial testing for one of the plurality of telecommunication user accounts retrieved in the workload;
automatically suggesting a workflow, from a plurality of workflows, to the technician based on the telecommunication user account information and the initial testing results; and
transmitting instructions associated with the suggested workflow to the client including a plurality of links to pre-selected diagnostic testing applications relating to the instructions.

11. The method of claim 10, further comprising associating the technician login with a profile for the technician, the profile comprising a plurality of login information for each of a plurality of diagnostic testing applications, and automatically logging the technician into each of the plurality of diagnostic applications.

12. The method of claim 10, wherein retrieving a workload comprises automatically prioritizing an order of the plurality of telecommunications user accounts assigned to the technician based on at least one priority parameter.

13. The method of claim 10, wherein the plurality of telecommunications accounts comprises a plurality of DSL subscriber accounts and wherein automatically executing an initial testing comprises testing network connectivity of an address for a DSL subscriber in the workload prior to transmitting telecommunication user account information to the client device.

14. The method of claim 13, further comprising automatically updating an activity log associated with the telecommunications user account with diagnostic test activity and results from the workflow.

15. The method of claim 10 further comprising transmitting instructions for generating a graphic user interface at the client device comprising concurrent display of an event log window for display of customer account database information and a test result window for displaying test results from at least one of a plurality of diagnostic testing applications.

16. The method of claim 15, further comprising transmitting instructions for generating a remarks window for technician entry of troubleshooting progress notes concurrently with the event log and testing windows.

17. A computer readable medium comprising instructions for carrying out the following steps:
receiving a technician login query from a client device;
retrieving a workload from a user account database, wherein the workload comprises a plurality of telecommunication user account information for telecommunication user account inquiries assigned to the technician;
automatically executing an initial testing of telecommunication user accounts retrieved in the workload;
transmitting to the client device information comprising telecommunication user account information and results of the initial testing for one of the plurality of telecommunication user accounts retrieved in the workload;
automatically suggesting a workflow, from a plurality of workflows, to the technician based on the telecommunication user account information and the initial testing results; and
transmitting instructions associated with the suggested workflow to the client including a plurality of links to pre-selected diagnostic testing applications relating to the instructions.

18. The computer readable medium of claim 17, wherein the instructions for wherein retrieving a workload further comprise instructions for automatically prioritizing an order of the plurality of telecommunications user accounts assigned to the technician based on at least one priority parameter.

19. The computer readable medium of claim 17, further comprising instructions for automatically updating an activity log associated with the telecommunications user account with diagnostic test activity and results from the workflow.

20. The computer readable medium of claim 17, further comprising instructions for exempting the technician from following the suggested workflow upon receipt of an exemption request from the technician.
